(19) United States
(12) Patent Application Publication
(10) Pub. No.: US 2009/0109452 A1
(43) Pub. Date: Apr. 30, 2009

(54) COLOR CONVERSION TABLE GENERATION APPARATUS AND COLOR CONVERSION TABLE GENERATION METHOD

(75) Inventor: Takayuki Sawada, Numazu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/877,742

(22) Filed: Oct. 24, 2007

(51) Int. Cl. H04N 1/60; H04N 1/407; G06K 15/00

(52) U.S. Cl. 358/1.9; 358/529

(57) ABSTRACT

A color conversion table generation apparatus includes black-maintenance-provisional-output generating means for generating provisional CMYK values, black-maintenance-degree evaluating means for calculating an index indicating a degree of black maintenance and evaluating a degree of black maintenance on the basis of a result of the calculation, black-maintenance-CMY searching means for fixing a K value of the provisional CMYK values which satisfy predetermined constraints concerning the index and searching for other CMY values, and recording means for recording CMYK values calculated by combining CMY values searched and obtained by the black-maintenance-CMY searching means and the K value fixed during the search in the black maintenance color conversion table. According to the color conversion table generation apparatus, it is possible to more easily generate an optimum black maintenance color conversion table desired by a user than conventional apparatus.

### BACKGROUND OF THE INVENTION

1. Field of the Invention

The present invention relates to an apparatus and a method for generating a table for color conversion, and, particularly to a color conversion table generation apparatus and a color conversion table generation method in which, for proof output of a CMYK image for print manuscript submission, both color reproduction simulation and texture simulation by black maintenance are accurately realized according to an intension of a user.

2. Related Art

In general, in a color conversion apparatus in a digital color printer, there is an advanced application for receiving CMYK (C means cyan, M means magenta, Y means yellow, and K means black; the C, M, Y and Kin the following explanation are used in same way) as an input signal and performing simulation for a final output device such as a printing device (press) using a color management technique to check finish of a color of a print in advance using a color printer before the color is processed by the press. This application is called print simulation or proof.

The color conversion apparatus employing the color management technique in the past usually includes input-color converting means for converting a color signal corresponding to a device on an input side (a color signal dependent on a device) into a color signal independent on a device and output-color converting means for converting the color signal (the color signal independent on a device) converted by this input-color converting means into a color signal corresponding to an output device (a color signal dependent on a device).

The input signal inputted to the color conversion apparatus (hereinafter, referred to as “input side CMYK signal”) is once converted into, for example, a color signal independent on a device such as CIELAB (hereinafter, referred to as “Lab signal”), which is standardized by the Commission Internationale de l'Eclairage (CIE), by the input-color converting means. The Lab signal as a color signal after the conversion is converted into a color signal corresponding to the output device (hereinafter, referred to as “output side CMYK signal”) by the output-color converting means.

In the print simulation, characteristics of the press and characteristics of the proof printer are applied as parameters for the input-color converting means and parameters for the output-color converting means, respectively.

As a result, a color signal for the press called input side CMYK signal from which a color called Lab is printed is converted into a color signal for the proof printer called the output side CMYK signal from which the same color called Lab is print-outputted. Thus, the Lab is reproduced and color simulation (color matching) is realized.

However, in the color conversion apparatus employing the conventional color management technique, since the input signal is once converted into the color signal independent on a device, there is a problem in that black print information of the input signal is lost. In the case of the print simulation application, it is insufficient that the color matching is simply realized by maintenance and transmission of the color signal independent on a device. There is a demand that information on black significantly affecting an image quality and texture in a final output should also be maintained.

As a result of the loss of the black information in the input signal, there are deficiencies in that, in the simulation, black occurs in a place where black is not present in the input and black present in the input is lost in the simulation. Thus, there is a problem in checking finish including the texture.

Therefore, there is proposed a color conversion apparatus that can maintain black of an image before conversion even in an image after conversion.

FIG. 3 is a diagram schematically illustrating the structure of a color conversion apparatus 100 as an example of the color conversion apparatus employing the technique in the past for performing the color matching while maintaining black information.

As shown in FIG. 3, the color conversion apparatus 100 includes color-conversion-table generating means 102 for creating a color conversion table 101 and color converting means 103 for performing color conversion on the basis of the color conversion table 101 created by the color-conversion-table generating means 102.

In the color conversion apparatus 100, prior to performing actual color conversion for an input signal, the color-conversion-table generating means 102 creates a device link table (a color conversion table) 101 that is a correspondence table of a pseudo-input signal (hereinafter referred to as first CMYK signal and shown as CMYK1 in FIG. 3) and a pseudo-output signal (hereinafter referred to as second CMYK signal and shown as CMYK2 in FIG. 3) obtained after performing color matching which practically maintaining black information.

In the color-conversion-table generating means 102, an input color converting unit 105 calculates first Lab (indicated as Lab1 in FIG. 3) on the basis of values (C1, M1, Y1, K1) indicated by the first CMYK signal as the pseudo-input signal inputted at appropriate intervals. A black generating unit 106 generates a black signal K2, which practically maintains the black information of the first CMYK signal, using the first CMYK signal and, if necessary, the first Lab. Next, the black generating unit 106 inputs the second CMYK signal generated by fixing black in the black signal K2 and appropriately setting the remaining C, M, and Y to an output-colorimetric-value converting unit 107 as a pseudo-input signal and converts the second CMYK signal into second Lab (shown as Lab2 in FIG. 3).

The first Lab transmitted from the input-color converting unit 105 and the second Lab transmitted from the output-colorimetric-value converting unit 107 are inputted to a comparing and determining unit 108. It is determined whether a difference between the first Lab and the second Lab are equal to or smaller than an allowable lower limit value (allowance) set in advance.

When the difference between the first Lab and the second Lab is equal to or smaller than the allowance, the comparing and determining unit 108 outputs values (C2, M2, Y2, K2) indicated by the second CMYK signal to the device link table 101 (in the case of YES shown in FIG. 3). When the difference between the first Lab and the second Lab is equal to or larger than the allowance, the comparing and determining unit 108 changes values of C, M, and Y in the second CMYK signal and determines again whether a difference between the first Lab and the second Lab after the change is equal to or smaller than the allowance (in the case of NO shown in FIG. 3). By repeating these steps (the second CMYK signal change steps and the color difference determination steps) until the difference is reduced to be equal to or lower than the allowance, a pseudo-output signal subjected to the color matching while maintaining the black information is obtained.

Incidentally, when the difference is not reduced to be equal to or smaller than the allowance even how many times the values of C, M, and Y in the values indicated by the second CMYK signal are changed, the black signal K2 is set again. Alternatively, measures such as selection of CMYK with a smallest color difference may be taken.

By applying the processing steps described above to all first CMYK signals generated at appropriate intervals, the second CMYK signal (the pseudo-output signal) subjected to the color matching while maintaining the black information with respect to the first CMYK signal as an arbitrary pseudo-input signal is stored in the device link table 101. The values (C2, M2, Y2, K2) indicated by the second CMYK signal are stored in the device link table 101 in order of addresses uniquely decided by the values (C1, M1, Y1, K1) indicated by the first CMYK signal.

After creating the device link table 101 in advance in this way, the color conversion apparatus 100 captures an actual input signal (hereinafter referred to as third CMYK signal and shown as CMYK3 in FIG. 3). The color conversion apparatus 100 outputs a signal for an output device (hereinafter referred to as fourth CMYK signal and shown as CMYK4 in FIG. 3) with reference to the device link table 101.

In creating the device link table 101, it is unrealistic to store pseudo-output signals (second CMYK signals) corresponding to all possible pseudo-input signals (first CMYK signals) because a data quantity and a table creation time are enormous. Therefore, the first CMYK signals are generated at appropriate intervals and only output signals at lattice points of the first CMYK signals are stored as second CMYK signals. In color conversion for an arbitrary input signal (third CMYK signal) actually inputted later, a fourth CMYK signal (CMYK4) is obtained by appropriately subjecting lattice point data near a position corresponding to the third CMYK signal (CMYK3) to interpolation processing out of the device link table 101.

In this way, the black maintenance color conversion processing in the color conversion apparatus 100 is executed using a black maintenance device link profile (the device link table) 101 generated on the basis of a source device (press) profile and a destination device (proof printer) profile.

Concerning a degree of black maintenance, since there is a tradeoff relation between the degree and accuracy of color simulation, in generating the black maintenance device profile, it is a problem to find a method of determining the black signal K2 that practically maintains the input black signal, i.e., a method of limiting a range of a K2 value with respect to a certain input color signal (C1, M1, Y1, K1). Concerning a specific range of values that the K2 value can take with respect to (C1, M1, Y1, K1), it is practical to experimentally calculate an optimum value matching an intention of a user.

However, in an example of the conventional apparatus such as the color conversion apparatus shown in FIG. 3 that performs the color matching while maintaining the black information, the black maintenance device link profile is merely generated generally and the user cannot arbitrarily adjust the black maintenance device link profile. Therefore, it is difficult to realize optimum black maintenance color conversion desired by the user.

Therefore, a color conversion apparatus that realizes optimum black maintenance color conversion desired by the user (at least a color conversion table generation apparatus that generates a black maintenance device link profile for realizing optimum black maintenance color conversion desired by the user) is desired.

An example of the conventional color conversion apparatus which maintains black information is disclosed in Japanese published unexamined Publication (Japanese Patent Laid-Open Publication) “JP-A-2003-324623”.

### SUMMARY OF THE INVENTION

The present invention has been devised in view of the circumstances described above and it is an object of the present invention to provide a color conversion apparatus and a color conversion method for realizing optimum black maintenance color conversion desired by a user (at least a color conversion table generation apparatus and a color conversion table generation method for generating a black maintenance device link profile for realizing optimum black maintenance color conversion desired by a user).

A color conversion table generation apparatus according to the present invention is an apparatus that generates a black maintenance color conversion table for obtaining a CMYK output that substantially maintains black for a proof output of a CMYK image for print manuscript submission. The color conversion table generation apparatus includes black-maintenance-provisional-output generating means for generating output CMYK provisional values with respect to input CMYK of black maintenance color conversion, black-maintenance-degree evaluating means for calculating an index indicating a degree of black maintenance in a relation between the input CMYK and the output CMYK provisional values and evaluating a degree of black maintenance on the basis of the calculated index, black-maintenance-CMY searching means for searching for respective values of C, M, and Y of the output CMYK with which a color difference between a color reproduced in proof output and a color reproduced by processing the input CMYK with a press is minimized under K of the output CMYK provisional values (an output K provisional value) generated by the black-maintenance-provisional-output generating means in order from a smallest value of the index in a range in which predetermined constraints concerning the index are satisfied, and recording means for recording, at least when the black-maintenance-CMY searching means succeeds in the search, CMYK values calculated by combining respective values of C, M, and Y obtained by the search and the output K provisional value in this case in the black maintenance color conversion table as a response of the black maintenance color conversion for the input CMYK.

A color conversion table generation method according to the present invention is a method of generating a black maintenance color conversion table for obtaining a CMYK output that substantially maintains black for a proof output of a CMYK image for print manuscript submission. The color conversion table generation method includes generating output CMYK provisional values with respect to input CMYK of black maintenance color conversion, calculating an index indicating a degree of black maintenance in a relation between the input CMYK and the output CMYK provisional values and evaluating a degree of black maintenance on the basis of the calculated index, searching for respective values of C, M, and Y of the output CMYK with which a color difference between a color reproduced in proof output and a color reproduced by processing the input CMYK with a press is minimized under K of the output CMYK provisional values (an output K provisional value) generated in order from a smallest value of the index in a range in which predetermined constraints concerning the index are satisfied, and recording, at least when the black-maintenance-CMY searching means succeeds in the search, CMYK values calculated by combining respective values of C, M, and Y obtained by the search and the output K provisional value in this case in the black maintenance color conversion table as a response of the black maintenance color conversion for the input CMYK.

According to the present invention, by introducing an index (a parameter) called a black texture difference indicating a degree of black maintenance, it is possible not only to represent a difference in black but also represent a difference in an impression due to the difference in black. Therefore, since a user can freely change a level of the black maintenance using the parameter called a black texture difference, which matches intuition, as a level index of the black maintenance, it is easy to generate an optimum black maintenance color conversion table desired by the user compared with the conventional color conversion.

### BRIEF DESCRIPTION OF THE DRAWINGS

In the accompanying drawings,

FIG. 1 is a diagram schematically illustrating the structure of a color conversion table generation apparatus according to the present invention;

FIG. 2 is a diagram schematically illustrating the structure of a black-maintenance-DLP generating unit in the color conversion table generation apparatus according to the present invention; and

FIG. 3 is a diagram schematically illustrating an example of the structure of a color conversion apparatus employing a technique in the past that performs color matching while maintaining black information.

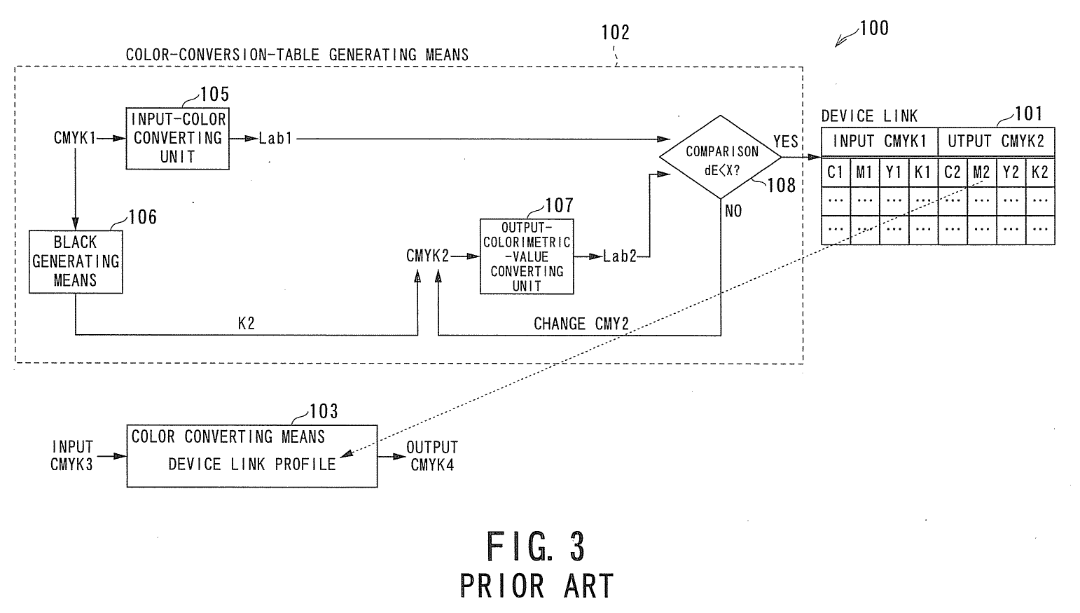

### DETAILED DESCRIPTION OF THE PREFERRED EMBODIMENT

An embodiment of a color conversion table generation apparatus according to the present invention is explained with reference to the accompanying drawings.

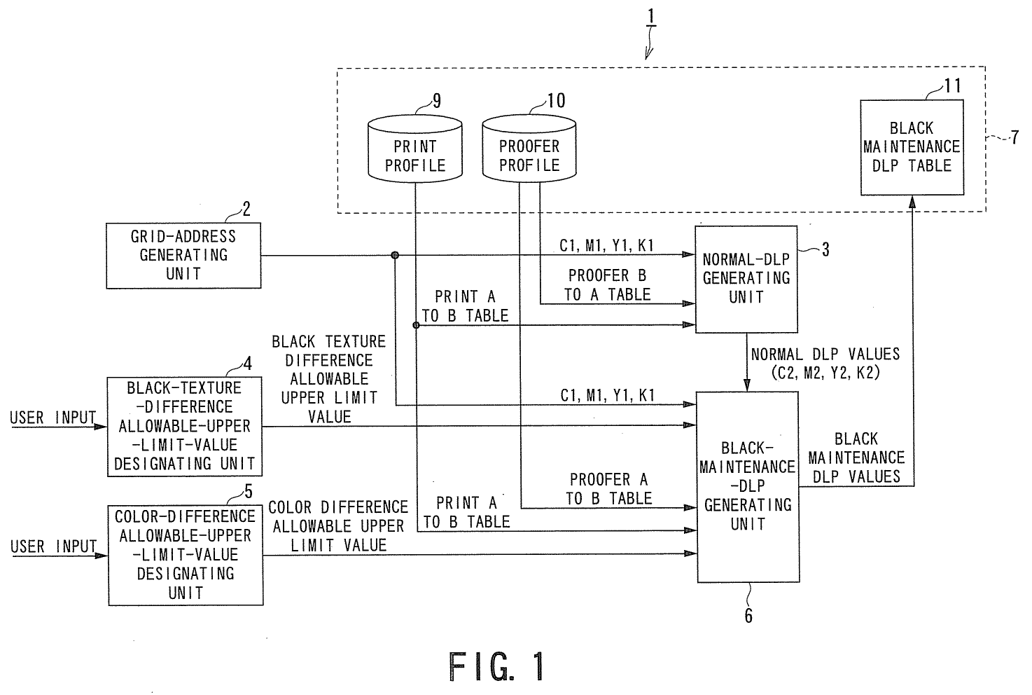

FIG. 1 is a diagram schematically illustrating the structure of a color conversion table generation apparatus 1 as an embodiment of the color conversion table generation apparatus according to the present invention.

As shown in FIG. 1, the color conversion table generation apparatus 1 includes a grid-address generating unit 2, a normal-device-link-profile generating unit (hereinafter, device link profile is abbreviated as “DLP”) 3, a black-texture-difference allowable-upper-limit-value designating unit 4, a color-difference allowable-upper-limit-value designating unit 5, and a black-maintenance-DLP generating unit 6.

In a memory 7 that stores electronic information, a print profile (a color profile of a press) 9, a proofer profile (a color profile of a press for proof) 10, and a black maintenance DLP table 11 referred to in color conversion processing involving black maintenance are stored.

The grid-address generating unit 2 generates a color signal dependent on a device such as CMYK represented by C (cyan), M (magenta), Y (yellow), and K (black) at appropriate intervals. The grid-address generating unit 2 transmits the generated CMYK signal to the normal-DLP generating unit 3 and the black-maintenance-DLP generating unit 6 as input color data (C1, M1, Y1, K1). The input color data (C1, M1, Y1, K1) is used when the normal-DLP generating unit 3 and the black-maintenance-DLP generating unit 6 calculate table contents of the DLP.

The normal-DLP generating unit 3 applies normal color conversion processing for not maintaining black to the input color data (C1, M1, Y1, K1) with reference to a print A to B table included (recorded) by the print profile 9 and a proofer B to A table included (recorded) by the proofer profile 10 stored in the memory 7. A conversion result is transmitted from the normal-DLP generating unit 3 to the black-maintenance-DLP generating unit 6 as normal DLP values (C2, M2, Y2, K2).

Here, the print A to B table is a color conversion table of conversion from a CMYK signal (a color signal dependent on a device) for a press (which is a device having a printing function) into a color signal not dependent on a device (hereinafter, referred to as “PCS color signal”). The proofer B to A table is a color conversion table for conversion from a PCS color signal into a CMYK signal for a proof printer.

The black-texture-difference allowable-upper-limit-value designating unit 4 is a user interface (hereinafter, abbreviated as “UI”) with which a user directly or indirectly designates an allowable upper limit value of a black texture difference described later. Information on a designated black texture difference allowable upper limit value is transmitted to the black-maintenance-DLP generating unit 6. In the present invention, the user may designate an allowable upper limit value of dK (a black change amount) in Equation 1 described later instead of designating black texture difference allowable upper limit value.

The color-difference allowable-upper-limit-value designating unit 5 is a UI with which the user directly or indirectly designates an allowable upper limit value of a color difference representing color accuracy of print simulation. Information on a designated color difference allowable upper limit value is transmitted to the black-maintenance-DLP generating unit 6. In the present invention, the user may designate an increase in a color difference instead of designating color difference allowable upper limit value.

The black-maintenance-DLP generating unit 6 applies color conversion processing involving black maintenance to the input color data (C1, M1, Y1, K1) on the basis of the input color data (C1, M1, Y1, K1), the normal DLP values (C2, M2, Y2, K2), the print A to B table, a proofer A to B table used when a CMYK signal for a proof printer is converted into a PCS color signal, the black texture difference allowable upper limit value information, and the color difference allowable upper limit value information. The black-maintenance-DLP generating unit 6 registers black maintenance DLP values obtained as a result of the color conversion processing in the black maintenance DLP table (the color conversion table) 11.

By executing the color conversion processing using the black maintenance DLP table 11 obtained in this way, as the color conversion table generation apparatus 1 can freely adjust a level of black maintenance in accordance with the user's requirement, the color conversion table generation apparatus 1 can realize black maintenance color conversion processing desired by the user.

Next, the black-maintenance-DLP generating unit 6 of the color conversion table generation apparatus 1 is explained more in detail.

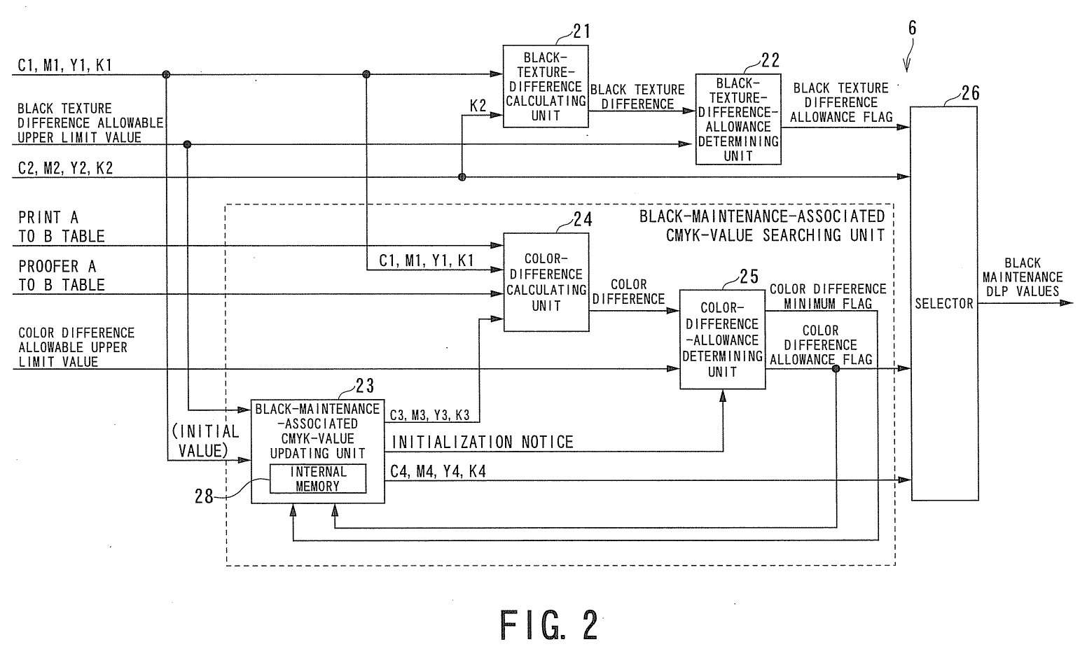

FIG. 2 is a schematic diagram illustrating the structure of the black-maintenance-DLP generating unit 6 in the color conversion table generation apparatus 1.

As shown in FIG. 2, the black-maintenance-DLP generating unit 6 includes a black-texture-difference calculating unit 21, a black-texture-difference-allowance determining unit 22, a black-maintenance-associated CMYK-value updating unit 23, a color-difference calculating unit 24, a color-difference-allowance determining unit 25, and a selector 26.

The black-texture-difference calculating unit 21 calculates a black texture difference (hereinafter, referred to as “IDB”) defined as indicated by Equation 1 below on the basis of the input color data (C1, M1, Y1, K1) and K2 of the normal DLP values (C2, M2, Y2, K2)

$$\begin{matrix}[ Equation 1 ] & \\ \begin{matrix}IDB = sqrt \{ ( L 1 + S 1 ) * dK * dK / max ( K 1 , K 2 ) \} \\ ( when K 1 \neq K 2 ) \\ \begin{matrix}IDB = 0 & ( when K 1 = K 2 )\end{matrix}\end{matrix} \} & ( 1 )\end{matrix}$$

### Here,

dK=K1−K2; (a black change amount)
dK/max(K1,K2); (a relative change amount of black)
(L1+S1); (a conspicuous degree of black (standardized to 0 to 255))
L1=(maxRGB1+minRGB1)/2.0*(255−darklevel)/255.0+darklevel; (simple lightness)
S1=(maxRGB1−minRGB1)/2.0*(255−darklevel)/255.0*weight; (simple chroma)
maxRGB1=255−min(C1, M1, Y1);
minRGB1=255−max(C1, M1, Y1);
darklevel=a first constant; and
weight=a second constant.

The black texture difference IDB is an index for representing a difference in an impression due to a difference in black and is represented as a real number equal to or larger than 0 and equal to or smaller than 255. A smaller value (closer to 0) of the IDB indicates that a degree of black maintenance is higher.

When the black-texture-difference calculating unit 21 calculates an IDB, the black-texture-difference calculating unit 21 transmits a value of the calculated IDB (black texture difference information) to the black-texture-difference-allowance determining unit 22.

The black-texture-difference-allowance determining unit 22 determines whether a black texture difference is equal to or smaller than the black texture difference allowable upper limit value on the basis of the black texture difference allowable upper limit value information transmitted from the black-texture-difference allowable-upper-limit-value designating unit 4 shown in FIG. 1 and the black texture difference information transmitted from the black-texture-difference calculating unit 21. The black-texture-difference-allowance determining unit 22 transmits a black texture difference allowance flag as a texture difference evaluation result from the black-texture-difference-allowance determining unit 22 to the selector 26. As the black texture difference allowance flag, “1” is set when a determination result is true, i.e., the black texture difference is equal to or smaller than the black texture difference allowable upper limit value and “0” is set when a determination result is false, i.e., the black texture difference exceeds the black texture difference allowable upper limit value.

The black-maintenance-associated CMYK-value updating unit 23 generates color data (C3, M3, Y3, K3), which is obtained by increasing respective values of CMYK at appropriate intervals with the input color data (C1, M1, Y1, K1) as an initial value, one after another on the basis of the black texture difference allowable upper limit value information transmitted from the black-texture-difference allowable-upper-limit-value designating unit 4 show in FIG. 1 and a color difference minimum flag and a color difference allowance flag transmitted from the color-difference-allowance determining unit 25. The generated color data (C3, M3, Y3, K3) is transmitted from the black-maintenance-associated CMYK-value updating unit 23 to the color-difference calculating unit 24. The black-maintenance-associated CMYK-value updating unit 23 transmits an initialization notice signal, which is “1” when the color data (C3, M3, Y3, K3) is initial values (C1, M1, Y1, K1), to the color-difference-allowance determining unit 25.

The black-maintenance-associated CMYK-value updating unit 23 generates the color data (C3, M3, Y3, K3) one after another in a flow explained below.

First, the black-maintenance-associated CMYK-value updating unit 23 updates a black signal K3 in a range in which a black texture difference in color conversion from (C1, M1, Y1, K1) to (C3, M3, Y3, K3) is equal to or smaller than the black texture difference allowable upper limit value (a K value updating step). Subsequently, the black-maintenance-associated CMYK-value updating unit 23 updates (C3, M3, Y3) in a state in which the black signal K3 is fixed (a CMY value updating step). Subsequently, when the update of (C3, M3, Y3) is finished through with the present K value (K3) and the color difference allowance flag is set to “1” immediately before K3 is updated, the black-maintenance-associated CMYK-value updating unit 23 finishes the update of (C3, M3, Y3, K3).

Moreover, the black-maintenance-associated CMYK-value updating unit 23 extracts color data (C4, M4, Y4, K4) to be candidates of black maintenance color conversion output values (i.e., black maintenance DLP values) for the input color data (C1, M1, Y1, K1) out of the generated color data (C3, M3, Y3, K3) on the basis of the color difference minimum flag transmitted from the color-difference-allowance determining unit 25. The black-maintenance-associated CMYK-value updating unit 23 stores the extracted color data (C4, M4, Y4, K4) in an internal memory 28 and transmits the color data (C4, M4, Y4, K4) to the selector 26.

Specifically, when the color difference minimum flag transmitted from the color-difference-allowance determining unit 25 is “1”, the black-maintenance-associated CMYK-value updating unit 23 replaces the color data (C4, M4, Y4, K4) stored in the internal memory 28 with the present color data (C3, M3, Y3, K3). On the other hand, when the color difference minimum flag is “0”, the black-maintenance-associated CMYK-value updating unit 23 maintains contents of the internal memory 28 without rewriting the contents.

In other words, the color data (C4, M4, Y4, K4) to be candidates of black maintenance DLP values, i.e., color data that is “equal to or smaller than the color difference allowable upper limit value and a minimum value among color differences after initialization up to the present” is stored in the internal memory 28. As initial values of (C4, M4, Y4, K4) stored in the internal memory 28, the input color data (C1 M1, Y1, K1) is used.

The black-maintenance-associated CMYK-value updating unit 23 transmits the color data (C4, M4, Y4, K4) stored in the internal memory 28 at a point when the update of the color data (C3, M3, Y3, K3) is finished to the selector 26 as final candidates of black maintenance DLP values for the present input initial values (C1, M1, Y1, K1).

The color-difference calculating unit 24 converts, using the print A to B table held by the print profile 9, the input color data (C1, M1, Y1, K1) into a PCS value, i.e., a color value (a first calorimetric value) outputted when (C1, M1, Y1, K1) is processed by the press.

The color-difference calculating unit 24 converts, using the proofer A to B table held by the proofer profile 10, the color data (C3, M3, Y3, K3) transmitted from the black-maintenance-associated CMYK-value updating unit 23 into a PCS value, i.e., a color value (a second calorimetric value) outputted when (C3, M3, Y3, K3) is given to the proof printer.

When the color-difference calculating unit 24 obtains the first calorimetric value and the second calorimetric value, the color-difference calculating unit 24 calculates a color difference ΔEab* between both the calorimetric values and transmits the color difference ΔEab* to the color-difference-allowance determining unit 25. Other color differences such as ΔE₉₄ and ΔE₂₀₀₀ may be used instead of ΔEab*.

The color-difference-allowance determining unit 25 evaluates, on the basis of the color difference allowable upper limit value information, color differences transmitted from the color-difference calculating unit 24 one after another. Specifically, when an inputted color difference is equal to or smaller than the color difference allowable upper limit value, the color-difference-allowance determining unit 25 changes a color difference allowance flag as a color difference evaluation result from an initial value “0” to “1” and transmits the color difference allowance flag from the black-maintenance-associated CMYK-value updating unit 23 to the selector 26.

After the color difference allowance flag is changed to “1”, the color difference allowance flag maintains the value “1” unless the color difference allowance flag is initialized. The initialization is executed when the initialization notice signal transmitted from the black-maintenance-associated CMYK-value updating unit 23 is “1”.

The color-difference-allowance determining unit 25 determines whether the color differences supplied from the color-difference calculating unit 24 one after another are “equal to or smaller than the color difference allowable upper limit value and a minimum value among color differences supplied after the initialization up to the present”. The color-difference-allowance determining unit 25 transmits information on a determination result (a color difference minimum flag) to the black-maintenance-associated CMYK-value updating unit 23. Specifically, the color-difference-allowance determining unit 25 sets the color difference minimum flag to “1” when the determination result is true, sets the color difference minimum flag to “0” when the determination result is false, and transmits the color difference minimum flag to the black-maintenance-associated CMYK-value updating unit 23.

The selector 26 selects and outputs, on the basis of the black texture difference allowance flag transmitted from the black-texture-difference-allowance determining unit 22 and the color difference allowance flag transmitted from the color-difference-allowance determining unit 24, one of two values, i.e., normal DLP values (CMYK values) transmitted from the normal-DLP generating unit 3 shown in FIG. 1 and the CMYK values transmitted from the black-maintenance-associated CMYK-value updating unit 23. This output is an output of the black-maintenance-DLP generating unit 6 shown in FIG. 1 and is recorded in the black maintenance DLP table 11 as black maintenance DLP values.

Specifically, the selector 26 selects the normal DLP values (C2, M2, Y2, K2) transmitted from the normal-DLP generating unit 3 when the black texture difference allowance flag is set to “1” and when both the black texture difference allowance flag and the color difference allowance flag are set to “0”, selects the CMYK values (C4, M4, Y4, K4) transmitted from the black-maintenance-associated CMYK-value updating unit 23 when the black texture difference allowance flag is “0” and the color difference flag is set to “1”, and outputs the values.

Next, a color conversion table generation method according to the present invention is explained.

The color conversion table generation method according to the present invention can be carried out, for example, when the color conversion table generation apparatus 1 executes a color conversion table generation procedure. The color conversion table generation procedure is explained below with reference to an example in which the color conversion table generation apparatus 1 executes the color conversion table generation procedure.

The color conversion table generation procedure includes a grid-address generating step of generating a grid address, a normal-DLP generating step of generating a DLP without black maintenance (a normal DLP) a black-texture-difference evaluating step of determining whether a black texture difference is in a predetermined range, a black-maintenance-associated CMYK-value updating step of searching for color data (CMYK values) corresponding to black maintenance, and a black-maintenance-DLP generating step including a black-maintenance-DLP-value recording step of extracting black maintenance DLP values and recording the black maintenance DLP values in the black maintenance DLP table 11.

In the color conversion table generation procedure, first, the grid-address generating unit 2 executes the grid-address generating step and a grid address (C1, M1, Y1, K1) is generated. Subsequently, the normal-DLP generating unit 3 executes the normal-DLP generating step to generate normal DLP values (C2, M2, Y2, K2).

When the grid address (C1, M1, Y1, K1) and the normal DLP values (C2, M2, Y2, M2) are generated, subsequently, the black-maintenance-DLP generating unit 6 executes the black-maintenance-DLP generating step. In the black-maintenance-DLP generating step, the black-texture-difference calculating unit 21 and the black-texture-difference-allowance determining unit 22 execute the black-texture-difference evaluating step of evaluating a black texture difference. The black-maintenance-associated CMYK-value updating unit 23, the color-difference calculating unit 24, and the color-difference-allowance determining unit 25 execute the black-maintenance-associated CMYK-value updating step of searching for color data (CMYK values) corresponding to black maintenance. The selector 26 executes the black-maintenance-DLP-value recording step.

As a flow of processing of the black-maintenance-DLP generating step, first, in the black-texture-difference evaluating step, a black texture difference (IDB) is calculated on the basis of the input color data (C1, M1, Y1, K1) and K2 of the normal DLP values (C2, M2, Y2, K2). It is determined whether the black texture difference (IDB) is equal to or smaller than the allowable upper limit value designated by the black-texture-difference allowable-upper-limit-value designating unit 4.

In the black-texture-difference evaluating step, first, the black-texture-difference calculating unit 21 calculates a black texture difference (IDB) and transmits the black texture difference (IDB) to the black-texture-difference-allowance determining unit 22. Subsequently, the black-texture-difference-allowance determining unit 22, which has received the black texture difference (IDB) transmitted from the black-texture-difference calculating unit 21, compares the black texture difference and the allowable upper limit value transmitted from the allowable-upper-limit-value designating unit 4. When the black texture difference is equal to or smaller than the allowable upper limit value, the black-texture-difference-allowance determining unit 22 transmits “1” to the selector 26 as a black texture difference allowance flag. When the black texture difference exceeds the allowable upper limit, the black-texture-difference-allowance determining unit 22 transmits “0” to the selector 26 as a black texture difference allowance flag.

When the selector 26 receives the black texture difference allowance flag “1”, the selector 26 executes the black-maintenance-DLP-value recording step and registers the normal DLP values (C2, M2, Y2, M2) in the black maintenance DLP table 11 as black maintenance DLP values. On the other hand, when the selector 26 receives the black texture difference allowance flag “0”, i.e., when the black texture difference exceeds the allowable upper limit value, in the black-maintenance-DLP-value recording step, the selector 26 registers color data obtained by execution of the black-maintenance-associated CMYK-value updating step as black maintenance DLP values. This is performed for all lattice points of the DLP.

In the black-maintenance-associated CMYK-value updating step, the black-maintenance-associated CMYK-value updating unit 23 sets initial values of (C3, M2, Y3, K3) to (C1, M1, Y1, K1) and fluctuates CMY values in a state in which a value (K1) of black K for the initial values is fixed. In the black-maintenance-associated CMYK-value updating step, the color-difference calculating unit 24 calculates, on the basis of the A to B table of the print profile 9 and the proof printer profile 10, a color difference between an output color at the time when (C3, M3, Y3, K3) is outputted by the proof printer and an output color by the press of the CMYK data for print manuscript submission (C1, M1, Y1, K1). When the color-difference-allowance determining unit 25 determines that the CMY values are CMY values with which the calculated color difference is equal to or smaller than the color difference allowable upper limit value and the color difference is minimized, the CMY values in that case and a K value at this point are extracted as black maintenance DLP values.

When CMY values that satisfy a condition that the proof printer output color is equal to or smaller than the color difference allowable upper limit value are not found, search same as that described above is performed in a state in which the value of black K is increased or decreased one stage and fixed. The search is executed until CMY values that satisfy the condition that a color difference is equal to or smaller than the color difference allowable upper limit value and the color difference is minimized are extracted. The extracted CMY values and a K value at this point, i.e., (C4, M4, Y4, K4) are extracted as black maintenance DLP values.

In case that K is increased or decreased one stage, note that a range of the increase or the decrease is a range in which a black texture difference from (C1, M1, Y1, K1) is equal to or smaller than the black texture difference allowable upper limit value. In case that CMY values that satisfy the color difference allowable upper limit value are not found to the end (when both the black texture difference allowance flag and the color difference allowance flag are “0”), an DLP output (C2, M2, Y2, K2) without black maintenance is registered as black maintenance DLP output values.

As described above, in the present invention, an index representing a degree of black maintenance (hereinafter referred to as black texture difference) is introduced and the user can directly or indirectly designate an upper limit value of the black texture difference and an upper limit value of a color difference from original pixels (a print CMYK original). Thus, when a device link profile (DLP) for black maintenance color conversion is generated, it is possible to generate a DLP for black maintenance color conversion under conditions desired by the user, i.e., conditions that the color difference from original pixels (a print CMYK original) is equal to or smaller than a desired threshold and the black texture difference is equal to or smaller than an upper limit value designated from the user interface.

The parameter called black texture difference defined as indicated by Equation (1) described above is calculated on the basis of a difference dK of black values before and after color conversion, (dK/max(K1,K2)) equivalent to a relative amount of the difference of the black values, and (L1+S1) equivalent to a conspicuous degree of a black value obtained by taking into account a relation between CMYK values for print manuscript submission and CMY values for color plates. Thus, it is possible to not only represent a difference in black but also represent a difference in an impression due to the difference in black. In other words, in the present invention, it is possible to provide a useful index that matches intuition as a level index of black maintenance called black texture difference.

According to the present invention, since both highly accurate color reproduction simulation and highly accurate texture simulation by black maintenance are optimally realized for proof output of a CMYK image for print manuscript submission, it is possible to easily control a degree of black maintenance.

Since a mechanism in which a user adjusts a level of black maintenance by designating a black texture difference is provided, it is easy to generate an optimum black maintenance color conversion table desired by the user compared with the past.

The present invention is not limited to the embodiment per se. At an implementation stage, the elements of the present invention may be modified and embodied without departing from the spirit thereof. For example, if the color conversion table generation apparatus 1 can read information of the print profile 9 and the proofer profile 10 stored in the memory 7, the color conversion table generation apparatus 1 may include or may not include the memory 7. The black-maintenance-associated CMYK-value updating unit uses the internal memory 28. However, the black-maintenance-associated CMYK-value updating unit may use a predetermined storage area allocated to the memory 7 instead of the internal memory 28.

What is claimed is:

1. An apparatus that generates a black maintenance color conversion table for obtaining a CMYK output that substantially maintains black for a proof output of a CMYK image for print manuscript submission, the color conversion table generation apparatus comprising:
black-maintenance-provisional-output generating means for generating output CMYK provisional values with respect to input CMYK of black maintenance color conversion;
black-maintenance-degree evaluating means for calculating an index indicating a degree of black maintenance in a relation between the input CMYK and the output CMYK provisional values and evaluating a degree of black maintenance on the basis of the calculated index;
black-maintenance-CMY searching means for searching for respective values of C, M, and Y of the output CMYK with which a color difference between a color reproduced in proof output and a color reproduced by processing the input CMYK with a press is minimized under K of the output CMYK provisional values (an output K provisional value) generated by the black-maintenance-provisional-output generating means in order from a smallest value of the index in a range in which predetermined constraints concerning the index are satisfied; and
recording means for recording, at least when the black-maintenance-CMY searching means succeeds in the search, CMYK values calculated by combining respective values of C, M, and Y obtained by the search and the output K provisional value in this case in the black maintenance color conversion table as a response of the black maintenance color conversion for the input CMYK.

2. The color conversion table generation apparatus according to claim 1, wherein the black-maintenance-degree evaluating means calculate, in the relation between the input CMYK and the output CMYK provisional values, the index on the basis of a difference between K of the input CMYK and K of the output CMYK provisional values, a quotient obtained by dividing the difference by any one of K of the input CMYK and K of the output CMYK provisional values, and a maximum value and a minimum value of three values C, M, and Y of the input CMYK.

3. The color conversion table generation apparatus according to claim 1, further comprising condition setting means for adjusting the black maintenance color conversion table by setting constraints concerning the index from the outside.

4. An apparatus that generates a black maintenance color conversion table for obtaining a CMYK output that substantially maintains black for a proof output of a CMYK image for print manuscript submission, the color conversion table generation apparatus comprising:
a black-maintenance-provisional-output generating unit configured to generate output CMYK provisional values with respect to input CMYK of black maintenance color conversion;
a black-maintenance-degree evaluating unit configured to calculate an index indicating a degree of black maintenance in a relation between the input CMYK and the output CMYK provisional values and evaluate a degree of black maintenance on the basis of the calculated index;
a black-maintenance-CMY searching unit configured to search for respective values of C, M, and Y of the output CMYK with which a color difference between a color reproduced in proof output and a color reproduced by processing the input CMYK with a press is minimized under K of the output CMYK provisional values (an output K provisional value) generated by the black-maintenance-provisional-output generating means in order from a smallest value of the index in a range in which predetermined constraints concerning the index are satisfied; and
a recording unit configured to record, at least when the black-maintenance-CMY searching means succeeds in the search, CMYK values calculated by combining respective values of C, M, and Y obtained by the search and the output K provisional value in this case in the black maintenance color conversion table as a response of the black maintenance color conversion for the input CMYK.

5. The color conversion table generation apparatus according to claim 4, wherein the black-maintenance-degree evaluating unit calculates, in the relation between the input CMYK and the output CMYK provisional values, the index on the basis of a difference between K of the input CMYK and K of the output CMYK provisional values, a quotient obtained by dividing the difference by any one of K of the input CMYK and K of the output CMYK provisional values, and a maximum value and a minimum value of three values C, M, and Y of the input CMYK.

6. The color conversion table generation apparatus according to claim 4, further comprising a condition setting unit configured to adjust the black maintenance color conversion table by setting constraints concerning the index from the outside.

7. A method of generating a black maintenance color conversion table for obtaining a CMYK output that substantially maintains black for a proof output of a CMYK image for print manuscript submission, the color conversion table generation method comprising:
generating output CMYK provisional values with respect to input CMYK of black maintenance color conversion;
calculating an index indicating a degree of black maintenance in a relation between the input CMYK and the output CMYK provisional values;
evaluating a degree of black maintenance on the basis of the calculated index;
searching for respective values of C, M, and Y of the output CMYK with which a color difference between a color reproduced in proof output and a color reproduced by processing the input CMYK with a press is minimized under K of the output CMYK provisional values (an output K provisional value) generated in order from a smallest value of the index in a range in which predetermined constraints concerning the index are satisfied; and
recording, at least when the black-maintenance-CMY searching means succeeds in the search, CMYK values calculated by combining respective values of C, M, and Y obtained by the search and the output K provisional value in this case in the black maintenance color conversion table as a response of the black maintenance color conversion for the input CMYK.

8. The color conversion table generation method according to claim 7, wherein, in the black maintenance degree evaluation, in the relation between the input CMYK and the output CMYK provisional values, the index is calculated on the basis of a difference between K of the input CMYK and K of the output CMYK provisional values, a quotient obtained by dividing the difference by any one of K of the input CMYK and K of the output CMYK provisional values, and a maximum value and a minimum value of three values C, M, and Y of the input CMYK.

9. The color conversion table generation method according to claim 7, further comprising adjusting the black maintenance color conversion table by setting constraints concerning the index from the outside.
